(19) United States
(12) Patent Application Publication
(10) Pub. No.: US 2010/0325572 A1
(43) Pub. Date: Dec. 23, 2010

(54) MULTIPLE MOUSE CHARACTER ENTRY

(75) Inventors: Mereidith J. Morris, Bellevue, WA (US); Saleema Amershi, Seattle, WA (US); Neema M. Moraveji, Palo Alto, CA (US); Ravin Balakrishnan, Toronto (CA)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/489,751

(22) Filed: Jun. 23, 2009

(51) Int. Cl. G06F 3/048

(52) U.S. Cl. 715/773; 715/856

(57) ABSTRACT

This document relates to multiple mouse character entry. More particularly, the document relates to multiple mouse character entry tools for use on a common or shared graphical user interface (GUI). In some implementations, the multiple mouse character entry tools (MMCE tools) can generate a GUI that includes multiple distinctively identified cursors. Individual cursors can be controlled by individual users via a corresponding mouse. The MMCE tools can associate a set of characters with an individual cursor effective that an individual user can use the mouse's scroll wheel to scroll to specific characters of the set. The user can select an individual character by clicking a button of the mouse.

### BACKGROUND

In much of the developed world, computers have changed almost every facet of life. In these areas the norm is for each person to have his/her own computer and maybe even multiple computers. Many citizens of the developing world are eager to become computer literate to expand their horizons of opportunity. However, in many of these areas, the norm of one user per computer is simply unaffordable. To address these cost considerations, a one computer per multiple users paradigm has been explored. The cost and/or logistics of using multiple input devices with a single computer has prevented successful implementation. Instead, the one computer per multiple user paradigm has generally been relegated to a passive learning experience with limited user-input.

### SUMMARY

This document relates to multiple mouse character entry. More particularly, the document relates to multiple mouse character entry tools for use on a common or shared graphical user interface (GUI). In some implementations, the multiple mouse character entry tools (MMCE tools) can generate a GUI that includes multiple distinctively identified cursors. Individual cursors can be controlled by individual users via a corresponding mouse or other cursor-control mechanism. The MMCE tools can associate a set of characters with an individual cursor in a manner such that an individual user can use the mouse's scroll wheel to scroll to specific characters of the set. The user can select an individual character by clicking a button of the mouse.

In other implementations, MMCE tools can generate a GUI that includes multiple distinctively identified cursors. Individual cursors can be controllable by individual users via a corresponding mouse, or other cursor-control mechanism. The MMCE tools can present a common virtual keyboard on the GUI that is accessible to individual users. An individual user can position an individual cursor over a key and select an individual character from the key by clicking a mouse button. The MMCE tools can populate the selected individual character on a portion of the GUI that is associated with the individual user.

The term “MMCE tool(s)” may refer to device(s), system(s), computer-readable instructions (e.g., one or more computer-readable media having executable instructions), component(s), module(s), and/or methods, among others. In various instances, MMCE tools may be implemented as hardware, software, firmware, or a combination thereof. The above listed examples of the summary are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIGS. 1, 12, and 18 are MMCE tools for use on a common GUI in accordance with some implementations.

FIGS. 2-11, 13-17 and 19-22 are exemplary GUI screenshots of multiple-mouse character entry concepts in accordance with some implementations.

FIGS. 23-24 are illustrations of example systems for accomplishing multiple-mouse character entry in accordance with some implementations.

### DETAILED DESCRIPTION

### Overview

This document relates to multiple mouse character entry (MMCE). More particularly, the document relates to MMCE tools for use on a common or shared graphical user interface (GUI). The shared GUI is generally generated by a single computer on a single display device (e.g., monitor) due to cost considerations. Multiple users can engage the computer via multiple individual input devices. However, in cost-conscious computing scenarios even the cost of multiple keyboards can be prohibitive. MMCE tools can enable reasonable character entry speeds with mice or other cursor-control mechanisms. MMCE tools can also reduce a footprint associated with character entry on the display. Accordingly, among other uses, MMCE tools can enable a better teaching and learning experience on a shared display. For instance, MMCE tools can allow short-answer activities in educational materials for shared-display multi-mouse systems.

### First MMCE Tool Example

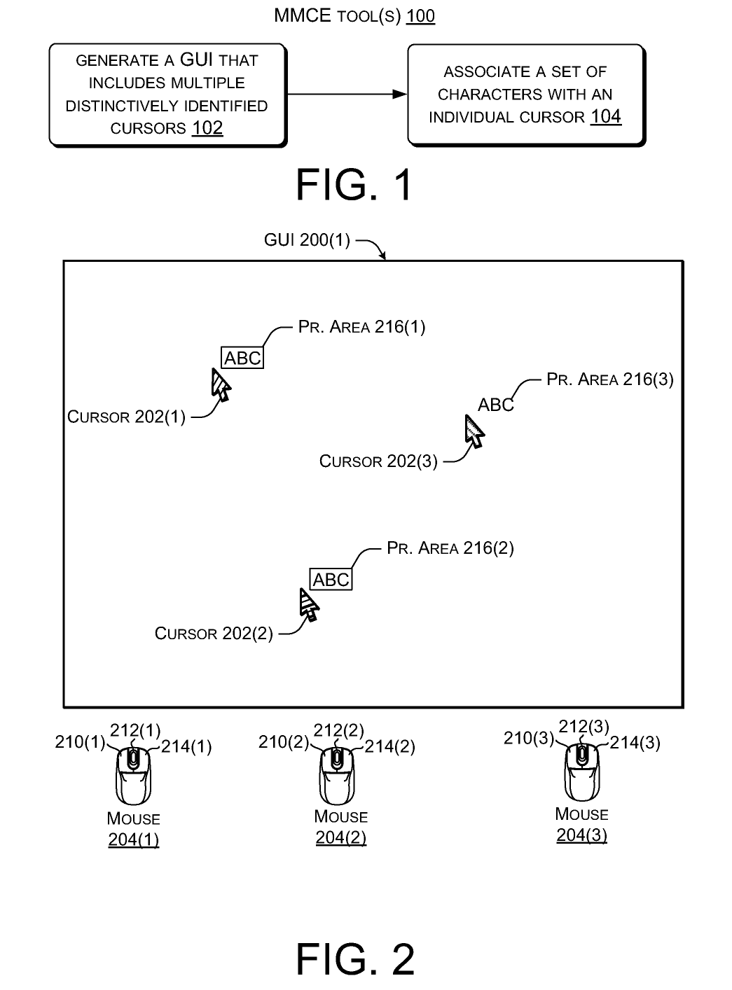

FIG. 1 shows an MMCE tool(s) 100 that can perform blocks 102 and 104. These blocks can be explained in more detail by way of an example relative to FIGS. 2-11. FIGS. 2-11 are described collectively with FIG. 1 to explain some of the present concepts.

Block 102 can generate a GUI that includes multiple distinctively identified cursors. Individual cursors can be controlled by individual users via a corresponding mouse. An example of such a GUI is introduced below relative to FIG. 2.

Block 104 can associate a set of characters with an individual cursor effective that an individual user can use the mouse's scroll wheel to scroll to specific characters of the set. In one case, the set of characters can be the alphabet (in any language). In another case, the set of characters can be letters (i.e., alphabet), numbers and/or symbols. The fact that the set of characters can be presented ‘virtually’ on the GUI can make the present implementations readily adaptable for use with different languages. In contrast, standard keys and keyboards are generally manufactured in English and are problematic to map to other languages (i.e., Russian, Japanese, etc.).

The user can select an individual character by clicking a button of the mouse. As mentioned above, in this discussion, a character can be any symbol, letter and/or numeral, among others. An example of such a GUI is introduced below relative to FIG. 2.

FIG. 2 shows a screenshot of a GUI 200(1). In this example GUI 200(1) includes three cursors 202(1), 202(2), and 202(3) that can be controlled via mice 204(1), 204(2), and 204(3), respectively. The cursors are distinctly identifiable based upon their different design element(s). For instance, cursor 202(1) includes a design element in the form of angled lines running bottom-left to upper-right. Cursor 202(2) includes a design element in the form of lines that are slightly canted from horizontal. Cursor 202(3) includes a design element in the form of lines running from upper-left to bottom-right. Alternatively or additionally, cursors can be distinguished by using a distinct color with each cursor. Still other examples for making cursors distinctly identifiable are described below relative to FIGS. 13-16 and 19-22.

As indicated on mouse 204(1), individual mice can include a left input button 210(1), a scroll wheel 212(1) and a right input button 214(1). These components are designated on mice 204(2) and 204(3) with like suffixes (i.e., suffix “(2)” on mouse 204(2) and suffix “(3)” on mouse 204(3)).

FIG. 2 shows an available character preview area (hereinafter, “preview area” 216(1) associated with cursor 202(1), a preview area 216(2) associated with cursor 202(2), and a preview area 216(3) associated with cursor 202(3). In the examples of cursors 202(1) and 202(2), the respective preview areas 216(1) and 216(2) are bounded by a border. In the example of cursor 202(3), preview area 216(3) does not include a border.

In this example each of preview areas 216(1)-216(3) includes three characters. On GUI 200(1) the characters are “A”, “B” and “C”. As will be described below in greater detail, a user can select a character from an individual preview area or scroll so that different characters are displayed in the preview area. The user can then select a character from the preview area. For instance, assume that a user of cursor 202(1) wants to enter the word “CAT”. The user can click the mouse's right input button 214(1) to select character “C”. (If the user wanted to enter an “A” the user could have clicked left input button 210(1). If the user had wanted to enter a “B” then the user could have clicked scroll wheel 212(1)).

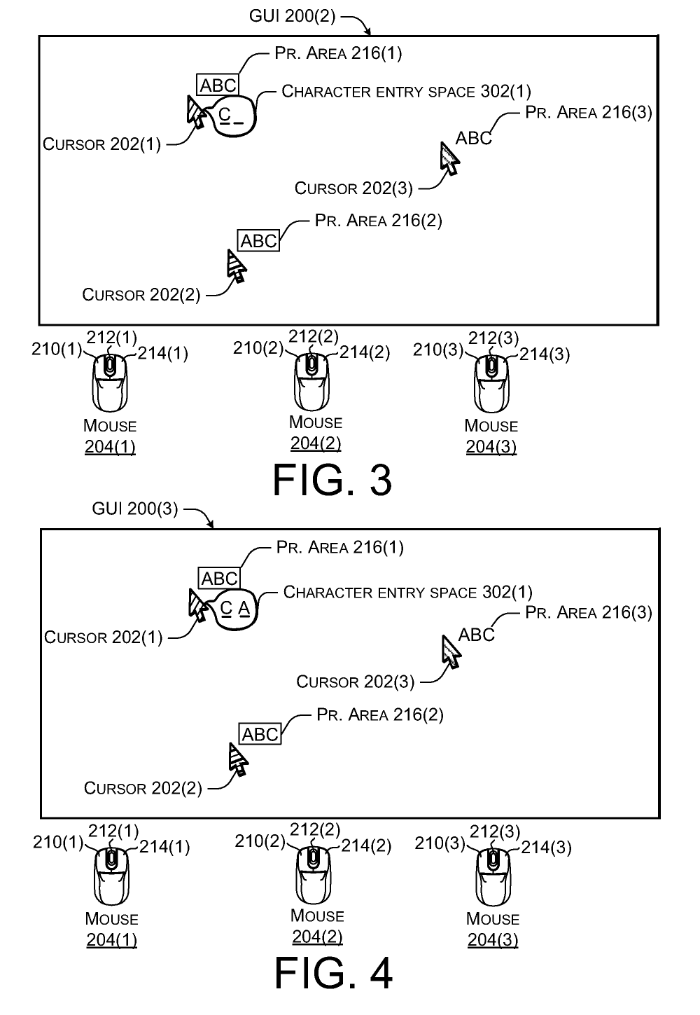

FIG. 3 illustrates a subsequent GUI 200(2) where the character “C” has been populated into a character entry space 302(1) associated with cursor 202(1). The user can then click the mouse's left input button 210(1) to input the letter “A”.

FIG. 4 shows a subsequent GUI 200(3) where character entry space 302(1) is populated with the letters “C” and “A”. Assume further that at this point the user scrolls through preview area 216(1) until the displayed characters are “S”, “T” and “U”.

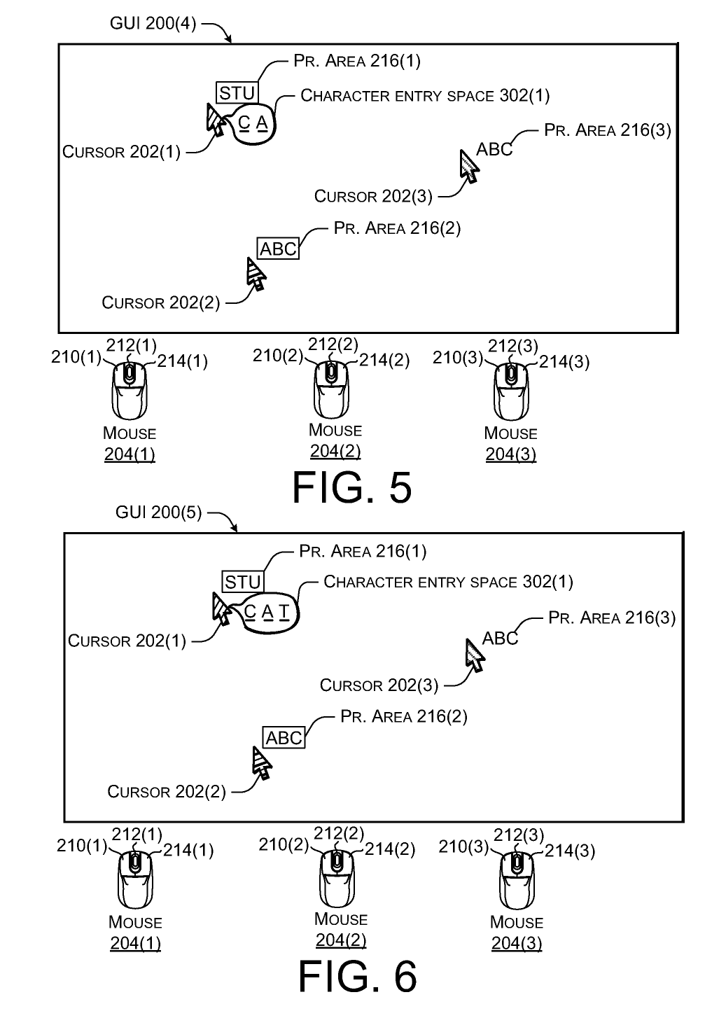

FIG. 5 shows an updated GUI 200(4) that reflects an updated preview area 216(1) that now shows the characters as “S”, “T” and “U”. The user can then click on scroll wheel 212(1) to select the letter “T”.

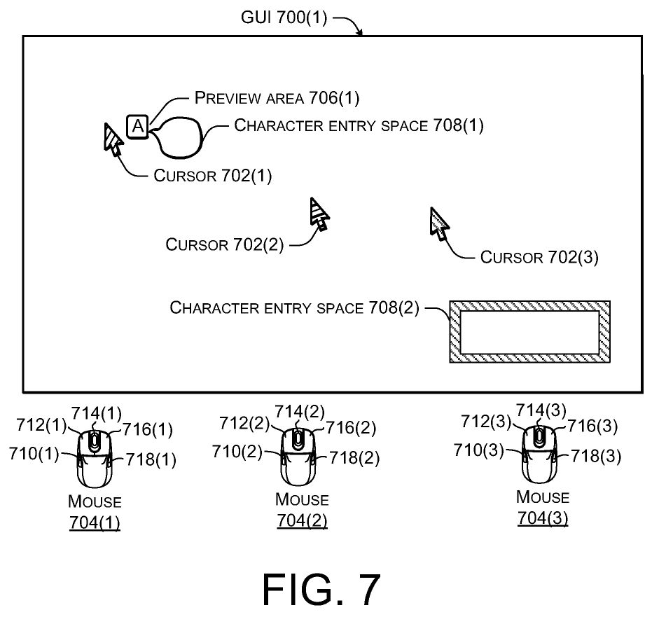

FIG. 6 shows a subsequent GUI 200(5) where character entry space 302(1) is populated with the letters “CAT” as desired by the user. In summary, FIGS. 2-6 offer an example of how an individual user can use the mouse's scroll wheel to scroll through presented characters of the preview area to find a desired character. The user can select an individual character of the preview area by clicking a button of the mouse that corresponds to a position of the character on the preview area. These steps can be repeated until the user has entered the desired characters. Additional examples are described below relative to FIGS. 7-11.

FIG. 7 shows a screenshot of a GUI 700(1) that shows further examples for multiple-mouse character entry. GUI 700(1) includes three cursors 702(1)-702(3) and associated mice 704(1)-704(3), respectively. This example uses three cursors and three mice for ease of illustration and explanation, but other implementations can have two cursors and mice or four or more cursors and mice.

In GUI 700(1), cursor 702(1) includes a preview area 706(1) that can list one or more characters and a character entry space 708(1). In this case, preview area 706(1) includes the character “A”. At this point, cursors 702(2)-702(3) are not associated with preview areas, though a character entry space 708(2) is shown that corresponds to cursor 702(3) (as indicated by the same design shared by character entry space 708(2) and cursor 702(3)).

As indicated on mouse 704(1), in this implementation, individual mice can include left side button 710(1), a left top button 712(1), a scroll wheel 714(1), a right top button 716(1), and a right side button 718(1). These components are designated on mice 704(2) and 704(3) with like suffixes (i.e., suffix “(2)” on mouse 704(2) and suffix “(3)” on mouse 704(3)).

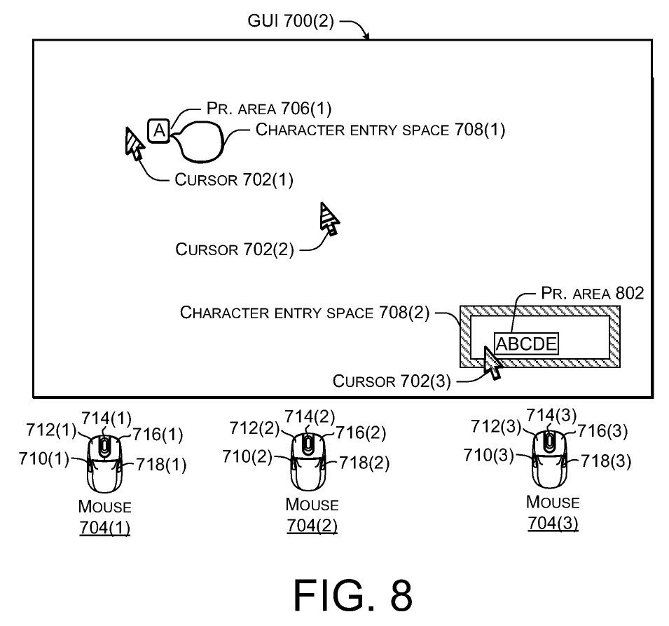

FIG. 8 shows a subsequent GUI 700(2) where a user of mouse 704(3) has positioned cursor 702(3) in character entry space 708(2). Positioning cursor 702(3) in character entry space 708(2) causes a preview area 802 to be associated with cursor 702(3) to allow character entry. In this configuration, the user's cursor maintains a traditional look-and-feel unless the user wants to enter characters and thus moves the cursor to the character entry space.

This implementation can include five characters on preview area 802: in this case “ABCDE”. The characters of preview area 802 are arranged in a generally horizontal fashion from left to right. The user can select an individual character of the preview area by clicking a corresponding mouse button. For instance, to select the left-most character (i.e., in this case “A”) the user can click the left side-button 710(3). To select the next character (i.e., in this case “B”) the user can click the left top button 712(3). To select the middle character (i.e., in this case “C”) the user can click the scroll wheel 714(3), etc.

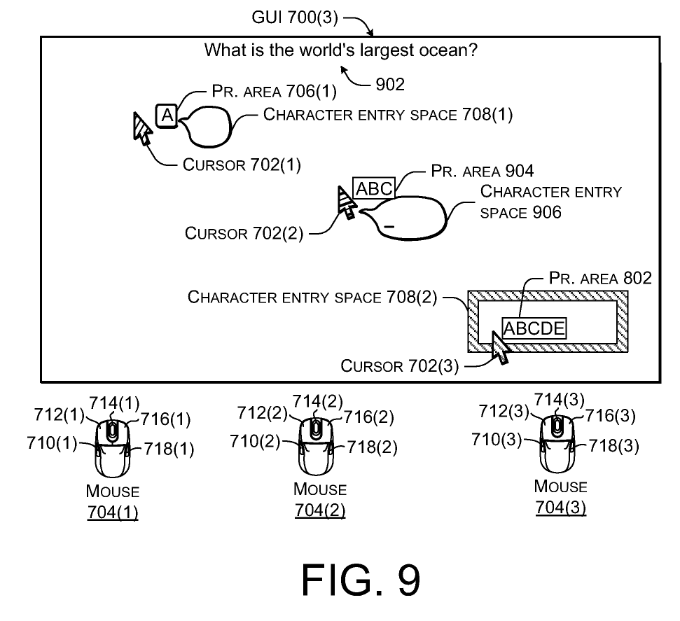

FIG. 8 offers an example where preview areas (and their characters) are associated with the cursor when a predetermined condition is satisfied. In this case, the predetermined condition is placing cursor 702(3) in character entry space 708(2). Another example of a predetermined condition is discussed below relative to FIG. 9. While FIGS. 2-8 illustrate specific numbers of characters in the preview areas, other implementations can utilize different numbers and/or orientations of characters in the preview area(s).

FIG. 9 shows a subsequent GUI 700(3) that includes question 902 that asks “What is the world's largest ocean?”. Assume for discussion purposes that GUI 700(3) can be generated when an administrator, such as a teacher, queues a computing device to present question 902. Stated another way, the teacher can issue a command queue, such as with a remote control, to forward a presentation. In another instance, an application that generates GUI 700(3) may automatically generate the question as part of a lesson. Note that the presentation of question 902 causes a preview area 904 of characters and a character entry space 906 to be associated with cursor 702(2). Stated another way, the question can act as a precondition that satisfies presenting preview area 904. Preview area 904 and character entry space 906 are configured similar to those described above relative to FIGS. 2-6 and, as such, are not described in more detail here.

Since the answer to question 902 is the word “PACIFIC” users of individual mice can scroll through their respective keys to find one that contains a “P”. For instance, the user of mouse 704(1) may scroll through a number of preview area views, such as 15 previews, to get to the preview with the character “P”. The user of mouse 704(2) can scroll through five previews to get to a preview with the character “P”. The user of mouse 704(3) can scroll through three keys to get to a preview with the character “P”.

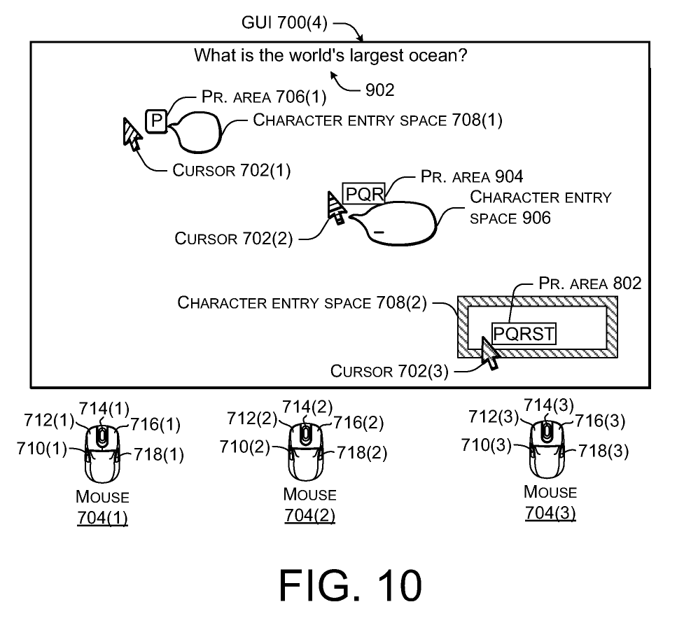

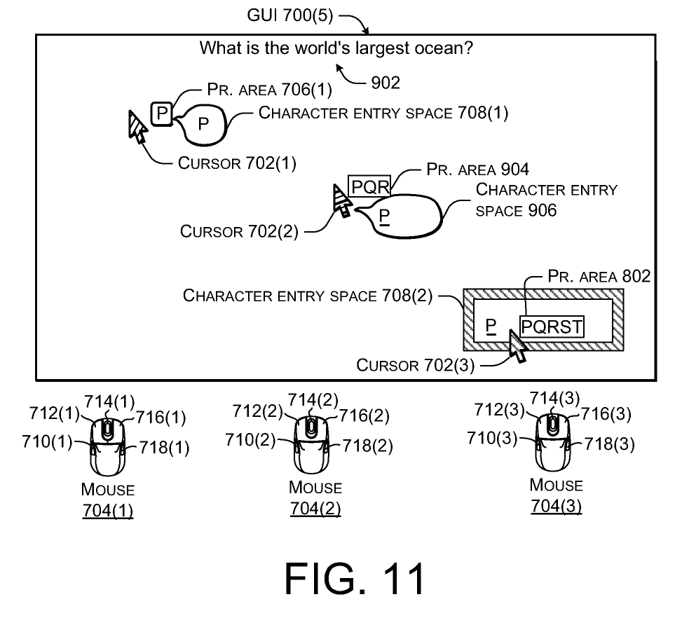

FIG. 10 reflects changes to GUI 700(4) after the users scroll through these respective preview areas. Specifically, preview area 706(1) shows a “P”, preview area 904 shows “PQR”, and preview area 802 shows “PQRST”. A user of mouse 704(1) can click any mouse button 710(1)-718(1) to select the “P”. A user of mouse 704(2) can click left top button 712(2) to select the “P”. A user of mouse 704(3) can click left side button 710(3) to select the “P”. These selections are represented in FIG. 11.

FIG. 11 shows a subsequent GUI 700(5) where character entry spaces 708(1), 708(2) and 906 reflect the selection of a “P” as described above. The users can continue to scroll through previews and select characters to finish entry of the word “PACIFIC”.

### Second MMCE Tool Example

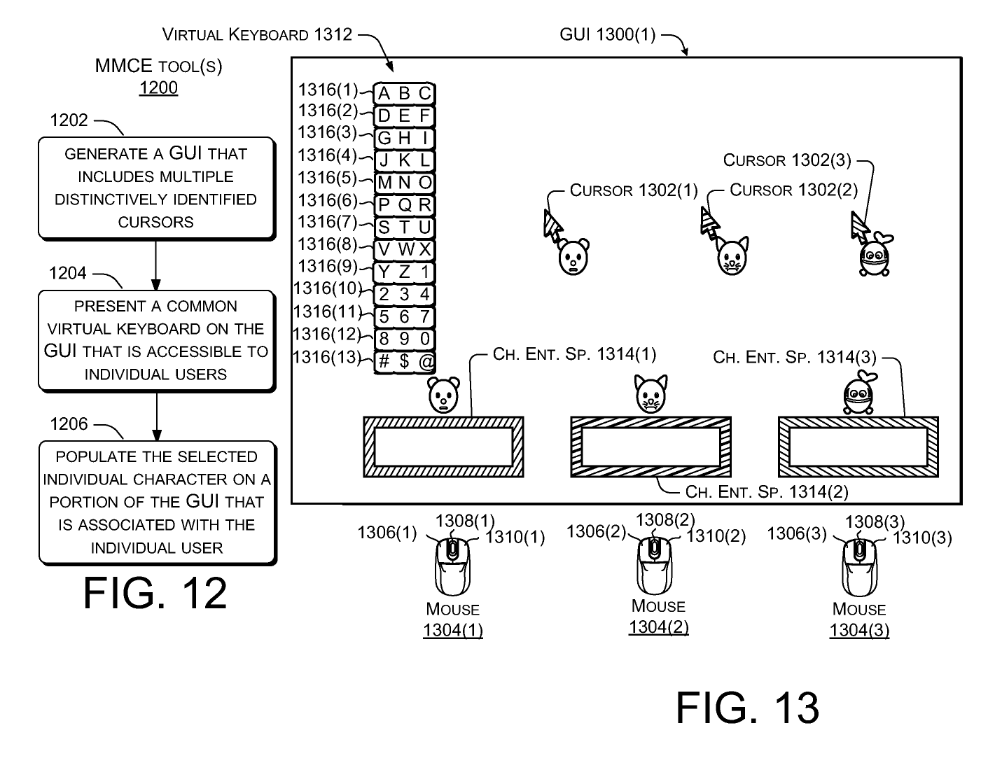

FIG. 12 shows an MMCE tool 1200 that can perform blocks 1202, 1204, and 1206. These blocks can be explained in more detail by way of examples relative to FIGS. 13-17 which are explained collectively with FIG. 12.

Block 1202 can generate a graphical user-interface (GUI) that includes multiple distinctively identified cursors. Individual cursors can be controlled by individual users via a corresponding mouse. Block 1202 is similar to block 102 and as such is not described in more detail herein.

Block 1204 can present a common virtual keyboard (hereinafter, “keyboard”) on the GUI that is accessible to individual users. An individual user can position an individual cursor over a key of the keyboard and select an individual character from the key by clicking a correspondingly positioned mouse button. The virtual keyboard can consist of letters, numbers and/or symbols.

Block 1206 can populate the selected individual character on a portion of the GUI that is associated with the individual user. The portion of the GUI can be thought of as a character entry space. The character entry space can be a fixed position on the GUI or can be proximate to, and move with, a respective cursor.

FIG. 13 shows a screenshot of a GUI 1300(1) that includes multiple cursors 1302(1)-1302(3) that are independently controllable via individual mice 1304(1)-1304(3). In this implementation, mice 1304(1)-1304(3) are three-button mice with a left input button 1306(1)-(3), respectively, a clickable scroll wheel 1308(1)-(3), respectively, and a right input button 1310(1)-(3), respectively.

GUI 1300(1) also includes a virtual keyboard 1312 and character entry spaces 1314(1)-1314(3) that correspond to individual cursors 1302(1)-1302(3). In this configuration, each cursor is distinctly identified via an associated animal design element which is also used to identify the associated character entry spaces 1314(1)-1314(3). In this implementation, virtual keyboard 1312 includes 13 keys designated as 1316(1)-1316(13). While FIG. 13 illustrates a virtual keyboard that is oriented vertically with a single set of stacked keys, other implementations can utilize other virtual keyboard configurations, such as having keys that are adjacent to one another horizontally.

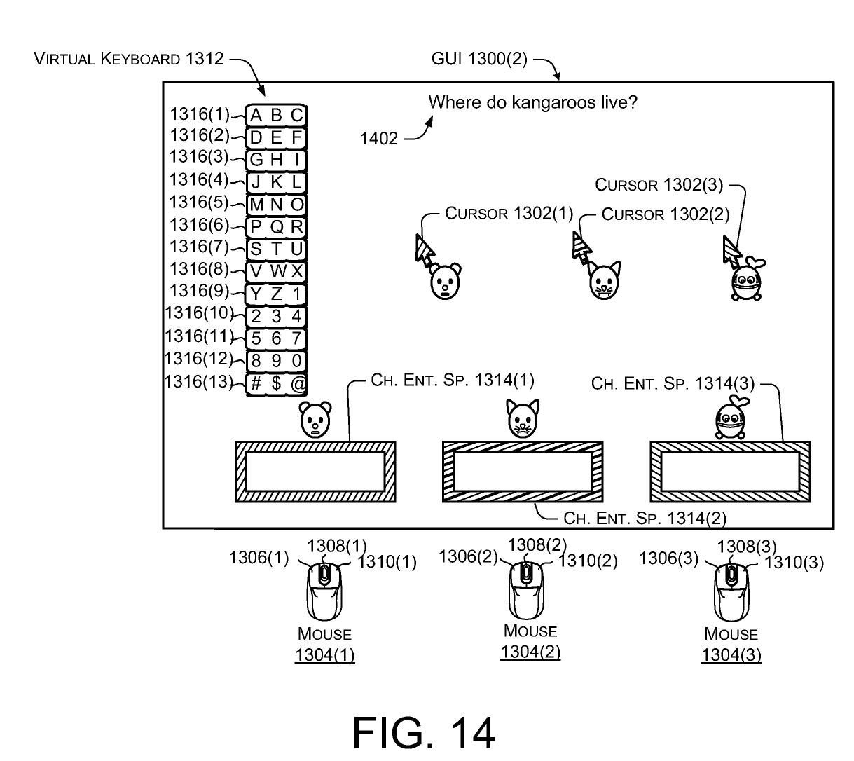

FIG. 14 shows a subsequent GUI 1300(2) where the application has asked the users (at 1402) “Where do kangaroos live?”.

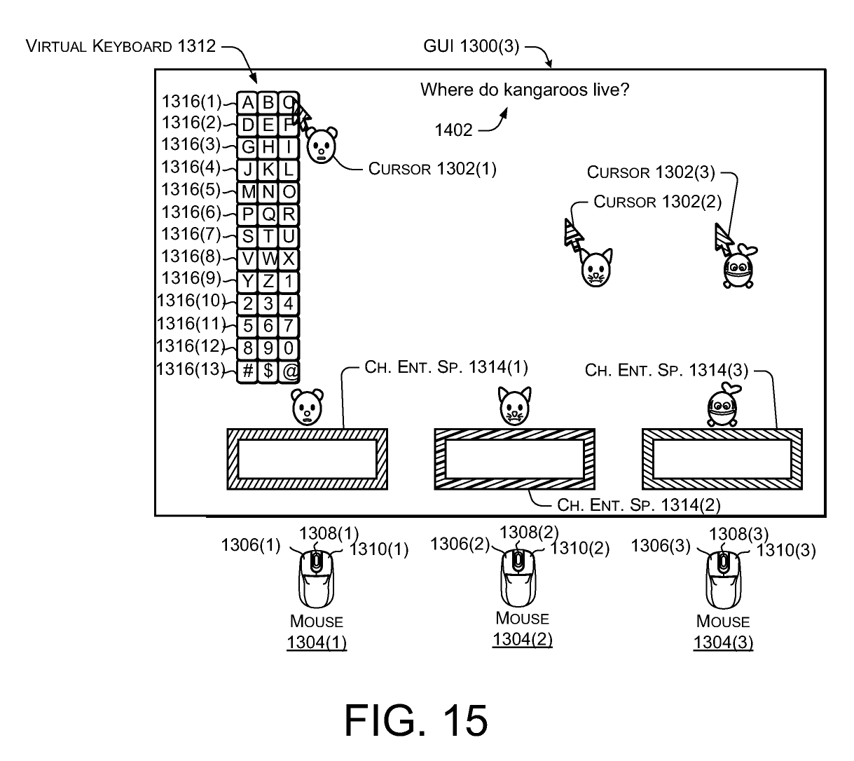

FIG. 15 shows a subsequent GUI 1300(3) where a user has moved cursor 1302(1) over key 1316(1). Once positioned over the cursor, the user can click left mouse input button 1306(1) to select a letter “A”. Assume that this procedure is also completed by users of cursors 1302(2) and 1302(3).

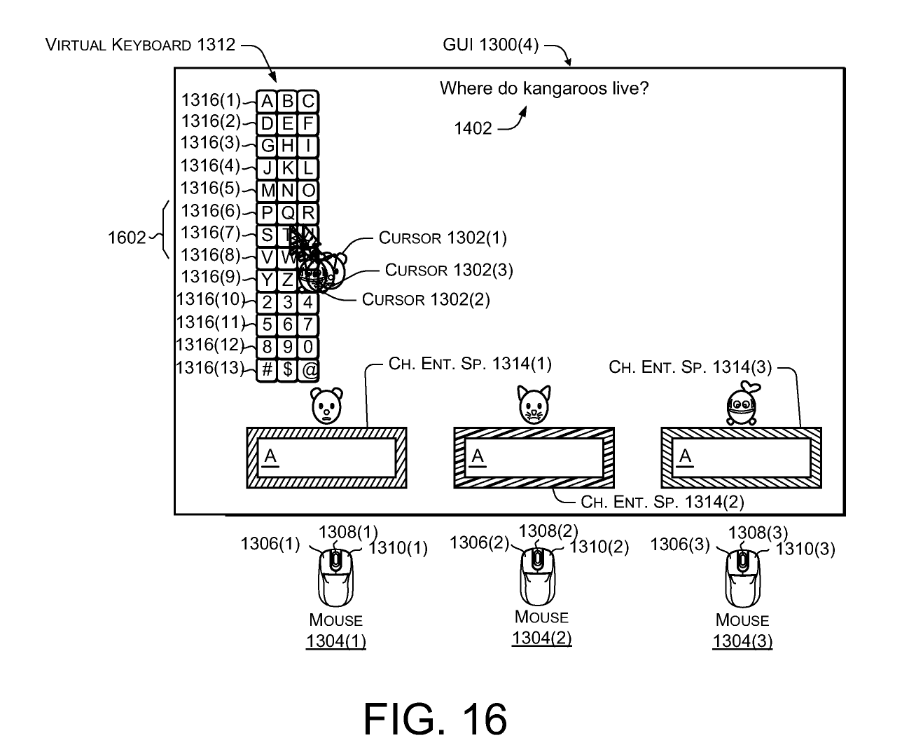

FIG. 16 shows a subsequent GUI 1300(4) where the letter “A” has been populated into the character entry spaces 1314(1)-1314(3) associated with cursors 1302(1)-1302(3). At this point in the process, the users have moved their respective cursors down to key 1316(7) which contains the letters “S”, “T” and “U”. The users can click their right mouse input button 1310(1)-1310(3) to select the letter “U”.

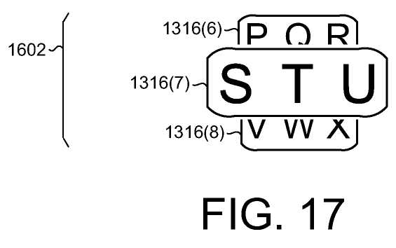

In some instances, especially in scenarios with relatively high numbers of users, a group of users trying to use a particular key can block or occlude some or all of that key from view and/or access. Such an occurrence is indicated generally at keyboard portion 1602. FIG. 17 illustrates a potential solution to such scenarios.

FIG. 17 is an enlarged view of keyboard portion 1602 that includes keys 1316(6), 1316(7) and 1316(8) (with the cursors removed for clarity). In this case, key 1316(7) had several cursors over it which may occlude some or all of the characters (i.e., letter “S”, “T” and “U”) listed on the key. To remedy this occlusion, key 1316(7) is temporarily enlarged relative to keys 1316(6) and 1316(8). This configuration can allow more room for the multiple cursors to be over key 1316(7) and/or make letters “S”, “T” and/or “U” more visible. Key 1316(7) can be returned to its standard size (as represented in FIG. 16) when the users make their selection and move their cursors off the key.

Enlargement of a key can be based upon satisfaction of a predefined condition. For instance, the predefined condition can be that if “X” number of cursors are positioned over an individual key then enlarge the key. For instance, assume that X is defined as three. In an instance where three of more cursors are detected over key 1316(7) then that key can be enlarged. When cursors are moved by users such that the predefined condition is no longer met, then the key can be returned to its normal size.

### Third MMCE Tool Example

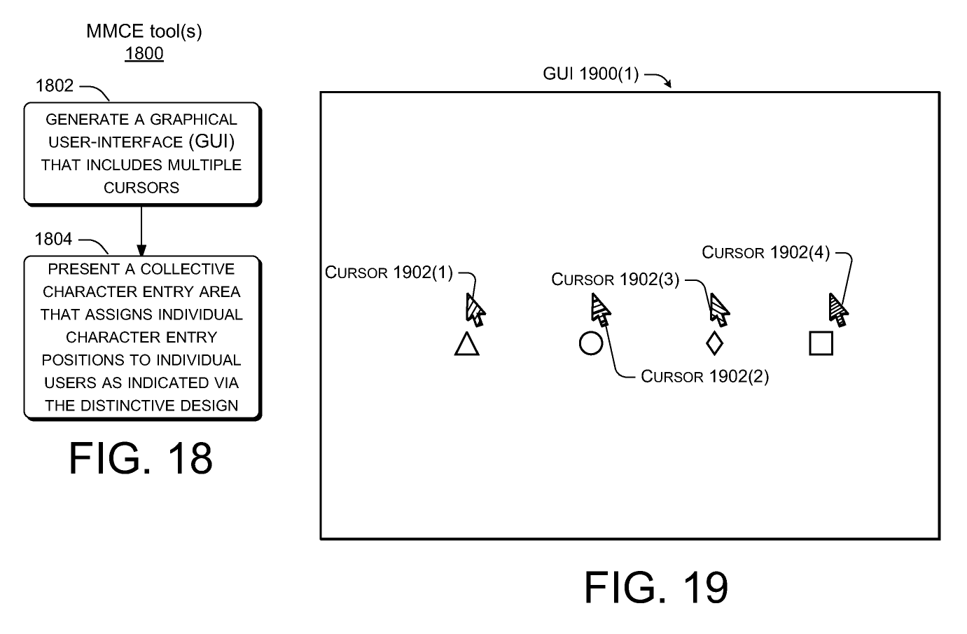

FIG. 18 shows an MMCE tool 1800 that can perform blocks 1802 and 1804. These blocks can be explained in more detail by way of example relative to FIGS. 19-22 which are explained collectively with FIG. 18.

The order in which the blocks are described is not intended to be construed as a limitation, and any number of the described blocks can be combined in any order to implement a method that can be accomplished by MMCE tool 1800, or an alternate method. Furthermore, the method can be implemented in any suitable hardware, software, firmware, or combination thereof, such that a computing device can implement the method. In one case, the method is stored on a computer-readable storage media as a set of instructions such that execution by a computing device causes the computing device to perform the method.

Block 1802 can generate a graphical user-interface (GUI) that includes multiple cursors. An individual cursor can be associated with a distinctive design. Individual cursors are controllable by individual users via a corresponding mouse. Such an example is described below relative to FIG. 19.

Block 1804 can present a collective character entry area that assigns individual character entry positions or spaces to individual users as indicated via the distinctive design. The user can complete character entry in the assigned character entry position. Upon completion, the user can be assigned a next available character entry position. For instance, the distinctive design associated with the user's cursor can be moved to the next character entry position. This process can be repeated so that the users can collectively fill in the collective character entry area.

FIG. 19 shows a screenshot of a GUI 1900(1) that includes the features of block 1802. In this case, GUI 1900(1) includes cursors 1902(1)-1902(4). These cursors are controllable by mice (not shown) in a manner consistent with the discussion above relative to FIGS. 1-17. Cursor 1902(1) is associated with a triangle design element. Cursor 1902(2) is associated with a circle design element. Cursor 1902(3) is associated with a diamond design element. Cursor 1902(4) is associated with a square design element.

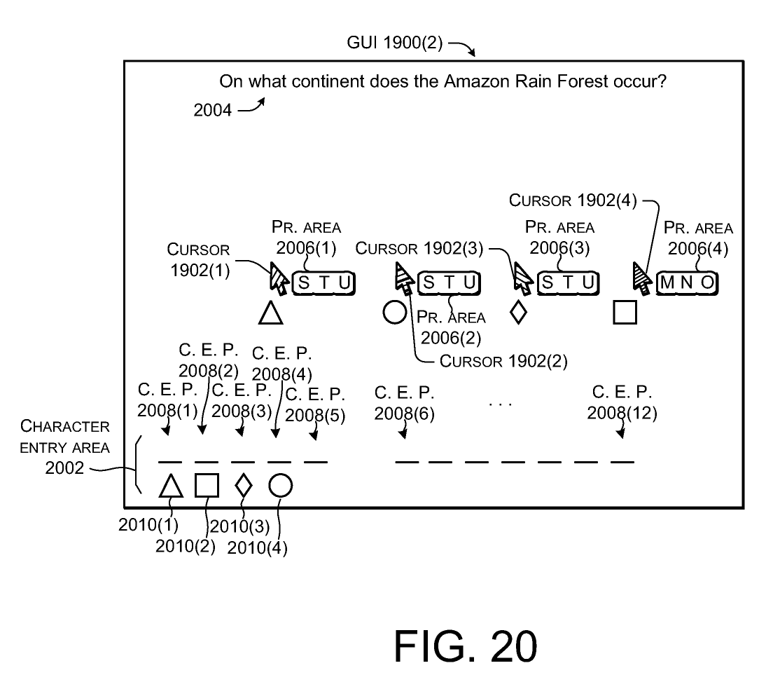

FIG. 20 shows a subsequent GUI 1900(2) with a collective character entry area 2002. The collective character entry area can be generated along with an instance where user input is desired. For example, in this case collective character entry area 2002 is presented concurrently with a question 2004 that asks “On what continent does the Amazon Rain Forest Occur?”. In this implementation, preview areas 2006(1)-2006(4) with three characters are populated proximate to each cursor. The user can scroll through his/her preview area and select from the characters of a preview area using left, center, or right inputs of the mouse.

In this example, collective character entry area 2002 includes 12 character entry spaces or positions 2008(1)-2008(12) (not all of which are designated with specificity). Character entry space 2008(1) is assigned to cursor 1902(1) as indicated by being associated with the cursor's triangle design element as indicated at 2010(1). Similarly, character entry space 2008(2) is assigned to cursor 1902(4) as indicated by the cursor's square design element as indicated at 2010(2). Similarly, cursor 1902(3) is assigned to character entry space 2008(3) as indicated by the diamond symbol at 2010(3). Finally, cursor 1902(2) is assigned to character entry space 2008(4) as indicated by the circle symbol at 2010(4). The user's can utilize their respective preview areas 2006(1)-2006(4) to select characters for entry in their assigned character entry spaces.

The first user to complete their respective character entry can be assigned the next unassigned character entry space. For instance, in the illustrated example, assume that the user of cursor 1902(4) is the first to complete his/her character entry.

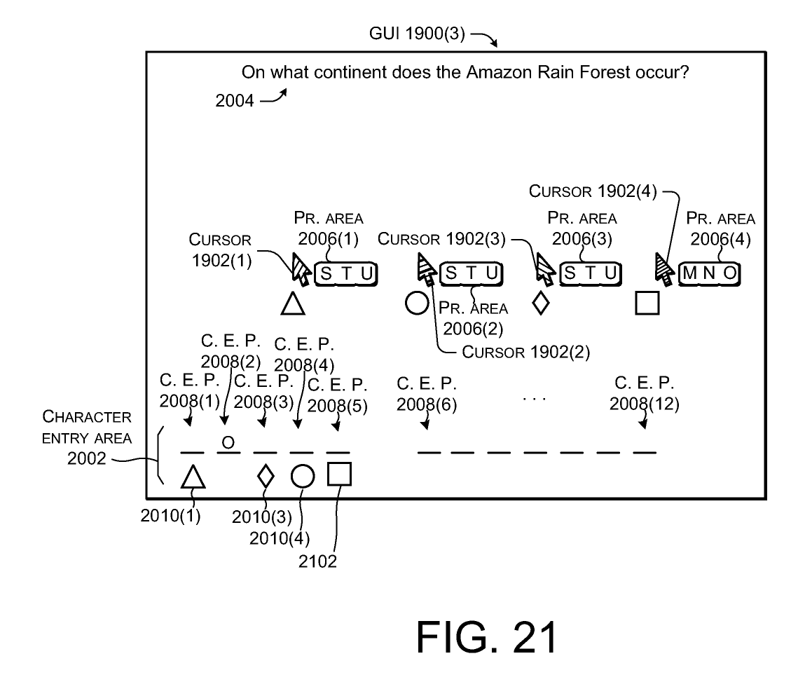

FIG. 21 shows GUI 1900(3) where cursor 1902(4) enters the letter “O” at character entry space 2008(2). Cursor 1902(4) can then be assigned character entry space 2008(5) as indicated by the accompanying design element indicated at 2102. The next user to finish his/her character entry can then be assigned the next unassigned character entry space 2008(6).

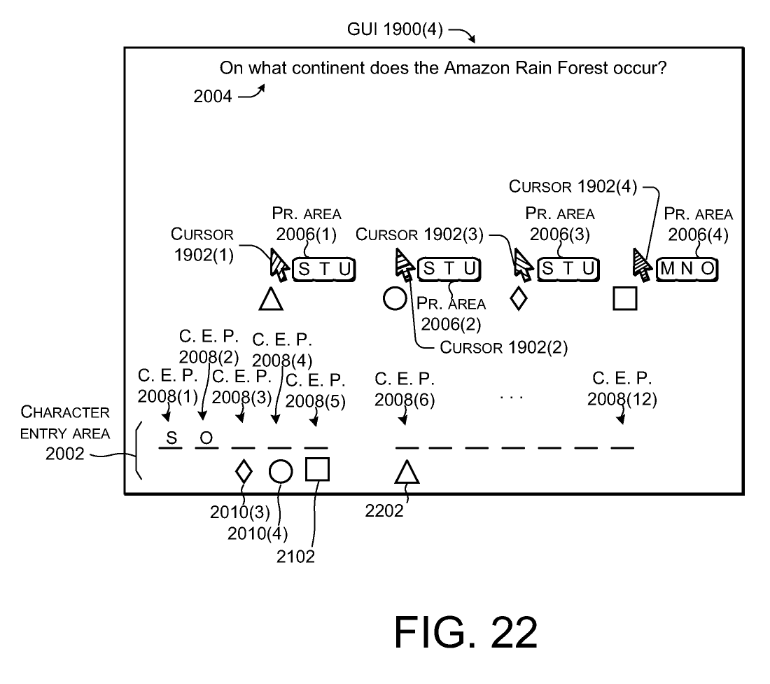

In this case, assume that user of cursor 1902(1) is the next to complete his/her character entry of “S”. As shown in GUI 1900(4) of FIG. 22, cursor 1902(1) can then be assigned character entry space 2008(6). The users can tell that character entry space 2008(6) is assigned to cursor 1902(1) since the cursor's triangle design element is positioned underneath at 2202. This process can be repeated, such as until all of the character entry spaces are assigned to individual users via the associated design elements and the character entry is completed.

An alternative character entry technique can be utilized with some of the above implementations. For instance, relative to FIG. 22, a user of cursor 1902(2) may want to input the letter “T” in their assigned character entry space 2008(4). Rather than using preview area 2006(2) the user can locate a “T” somewhere on GUI 1900(4) such as in question 2004. The user can hold down one of the cursor's input buttons while swiping the cursor over the “T”. The swiped character can then be populated to the user's assigned character entry space 2008(4) just as if the user had utilized a key entry technique. This technique can be utilized to select a single character at a time and/or to select multiple characters and/or even words at a time.

### First System Example

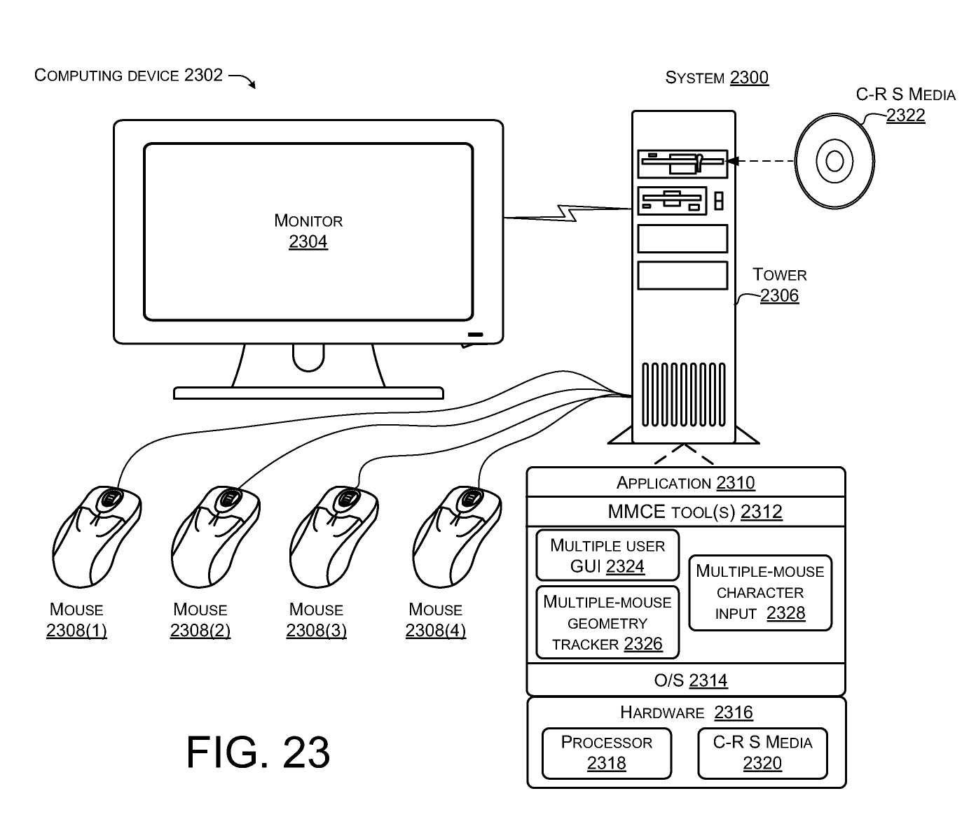

FIG. 23 shows a system 2300 for generating a shared GUI. In this case, system 2300 includes a computing device 2302 that includes a monitor 2304, a housing or tower 2306, and in this case, four mice 2308(1)-2308(4). Tower 2306 can include an application(s) 2310 and MMCE tools 2312 that can operate upon an operating system 2314 and a hardware layer 2316. The hardware layer can include a processor 2318 and computer-readable storage media 2320. The operating system and hardware layer are presented to orient the reader and thus are not described further herein. MMCE tools 2312 can be stored as instructions on computer-readable storage media 2320 and/or upon computer-readable storage media 2322, such as on a compact disc, DVD, flash-drive, etc.

MMCE tools 2312 can include a multiple-user GUI module 2324, a multiple-mouse geometry tracker module 2326, and a multiple-mouse character input module 2328.

Multiple-user GUI module 2324 can generate a graphical user interface that can include multiple independently controllable cursors. The multiple user GUI module can also associate some type of area in which a character entry associated with an individual cursor can be displayed. Various examples are described above relative to FIGS. 2-11, 13-16 and 19-22.

Multiple-user GUI module 2324 can be configured to generate some way to distinguish the individual cursors from one another. For instance, any combination of designs, colors, shapes, etc can be associated with individual cursors. Several examples are illustrated relative to FIGS. 2-11, 13-16 and 19-22. Users can engage individual cursors via manipulation of individual mice 2308(1)-2308(4).

Multiple-mouse geometry tracker module 2326 tracks manipulation of individual mice 2308(1)-2308(4). The multiple-mouse geometry tracker module can reflect mouse manipulation in the form of ‘movement’, ‘scrolling’, and/or ‘clicking’. The multiple-mouse geometry tracker module can cause mouse manipulation to be reflected in the corresponding cursor.

Multiple-mouse character input module 2328 can correlate user character selections (recorded as mouse scrolling and/or clicking) with specific characters. The multiple-mouse character input module can cause the selected characters to be visualized by the multiple-user GUI module 2324 in the character entry area of the corresponding cursor.

### Second System Example

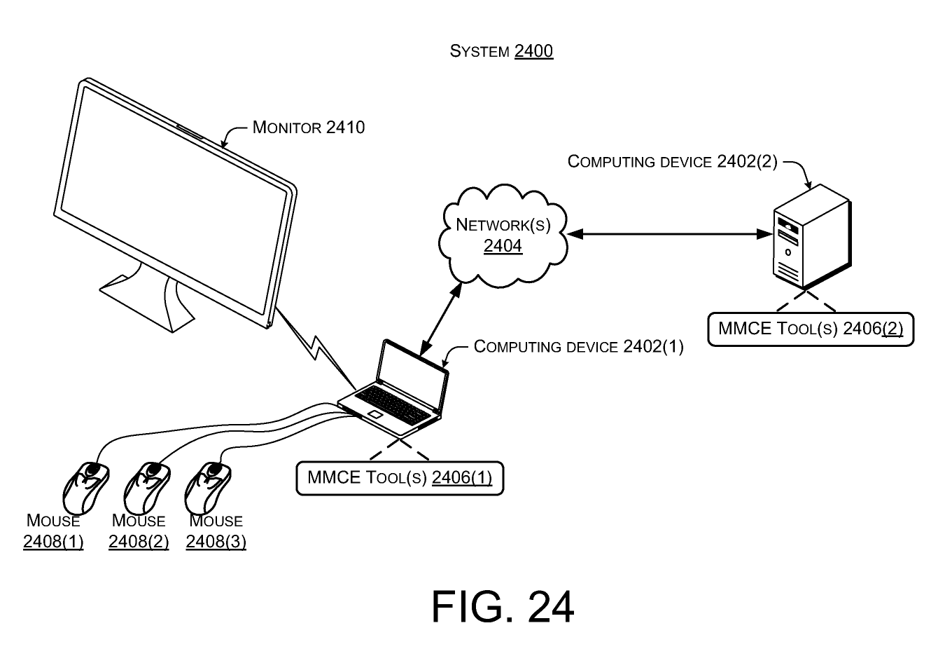

FIG. 24 shows a system 2400 for generating a shared GUI. System 2400 includes two computing devices 2402(1) and 2402(2). The computing devices can be coupled via one or more networks 2404, such as a local area network and/or a wide area network, such as the Internet.

In this case, computing device 2402(1) is manifest as a notebook computer and computing devices 2402(2) is manifest as server. In other cases, individual computing devices can be manifested in different forms than those illustrated here. Computing device 2402(1) is coupled to mice 2408(1)-2408(3) in a wired or wireless fashion. In this case, computing device 2402(1) is also coupled to a monitor 2410 which has a larger display area than that of computing device 2402(1).

One or both of computing devices 2402(1)-2402(2) can include MMCE tools. For discussion purposes, computing device 2402(1) is shown as including MMCE tool 2406(1) and computing device 2402(2) is shown as including MMCE tool 2406(2). In a stand-alone configuration, similar to that of FIG. 23, MMCE tool 2406(1) can provide an MMCE functionality via mice 2408(1)-2408(3) and monitor 2410. In another configuration, MMCE tool 2406(1) and MMCE tool 2406(2) can operate cooperatively to create the MMCE functionality. In still another configuration, MMCE tool 2406(2) can provide the processing to achieve the MMCE functionality on computing device 2402(1). In such a case, MMCE tool 2406(1) may not even be present on computing device 2402(1).

### CONCLUSION

Although the subject matter has been described in language specific to structural features and/or methodological acts, it is to be understood that the subject matter recited in the appended claims is not necessarily limited to the specific features or acts described above. Rather, the specific features and acts described above are disclosed as example forms of implementing the claims.

What is claimed is:

1. One or more computer-readable media having computer-executable instructions that, when executed by a computing device, perform acts comprising:
generating a graphical user interface (GUI) that includes multiple distinctively identified cursors, wherein individual cursors are controllable by individual users via a corresponding mouse; and,
associating a set of characters with an individual cursor effective that an individual user can scroll to specific characters of the set utilizing a scroll wheel of the mouse and can select an individual character by clicking a button of the mouse.

2. The media of claim 1, wherein individual cursors are distinctly identified by showing an image of a particular animal with an individual cursor or individual cursors are distinctly identified via design color or pattern of an individual cursor.

3. The media of claim 1, wherein the scroll wheel is configured to provide both a scrolling function and a button function.

4. The media of claim 1, wherein the set of characters are displayed in sub-sets of three characters presented generally horizontally on the GUI from left to right such that the user can select an individual character from a sub-set by clicking a correspondingly oriented left mouse button, the scroll wheel, or a right mouse button.

5. The media of claim 1, wherein individual characters of the set of characters are displayed for user selection on a preview area and wherein a user-selected individual character is populated into a character entry space associated with the individual user that selected the character.

6. The media of claim 1, wherein the set of characters are displayed in sub-sets of five characters presented generally horizontally on the GUI from left to right such that the user can select an individual character from a sub-set by clicking a correspondingly oriented left side mouse button, a left top button, the scroll wheel, a right top button, or a right side mouse button.

7. The media of claim 1, wherein the set of characters includes one or more of: letters, numbers, or symbols.

8. The media of claim 1, further comprising allowing the individual user to select one or more characters from the GUI by swiping the cursor over the one or more characters while pressing the mouse button.

9. One or more computer-readable media having computer-executable instructions that, when executed by a computing device, perform acts comprising:
generating a graphical user-interface (GUI) that includes multiple distinctively identified cursors, wherein individual cursors are controllable by individual users via a corresponding mouse;
presenting a common virtual keyboard on the GUI that is accessible to individual users, wherein an individual user can position an individual cursor over a virtual key of the virtual keyboard and can select an individual character from the virtual key by clicking a mouse button; and,
populating the selected individual character on a portion of the GUI that is associated with the individual user.

10. The media of claim 9, wherein the mouse button comprises a left mouse button, a center scroll wheel, and a right mouse button, and wherein individual virtual keys include characters presented generally horizontally on the GUI from left to right such that the user can select an individual character from an individual virtual key by clicking a correspondingly oriented left mouse button, scroll wheel, or right mouse button.

11. The media of claim 9, wherein the mouse button comprises a left side mouse button, left top mouse button, a center scroll wheel, a right top mouse button, and a right side mouse button, and wherein individual virtual keys include five characters presented generally horizontally on the GUI from left to right such that the user can select an individual character from an individual virtual key by clicking a correspondingly oriented left side mouse button, left top mouse button, center scroll wheel, right top mouse button, or right side mouse button.

12. The media of claim 9, further comprising enlarging an individual virtual key relative to other virtual keys upon satisfaction of a predefined condition.

13. The media of claim 12, wherein the predefined condition relates to a number of cursors positioned over the individual virtual key.

14. The media of claim 9, further comprising tracking cursor position relative to individual virtual keys and enlarging an individual virtual key when a predefined number of cursors are positioned over the individual virtual key.

15. The media of claim 14, further comprising restoring the individual key to an original size when a number of cursors over the individual key falls below the predefined number.

16. The media of claim 9, further comprising allowing the individual user to select one or more characters from the GUI by swiping the cursor over the one or more characters while pressing the mouse button.

17. One or more computer-readable media having computer-executable instructions that, when executed by a computing device, perform acts comprising:
generating a graphical user-interface (GUI) that includes multiple cursors, wherein an individual cursor is associated with a distinctive design element, wherein individual cursors are controllable by individual users via a corresponding cursor-control mechanism; and,
presenting a collective character entry area that assigns individual character entry positions to individual users as indicated via the distinctive design element, and wherein when an individual user enters a character in the assigned character entry position, the user is assigned a next available character entry position by moving the distinctive design element to the next character entry position effective that the users can collectively fill in the collective character entry area.

18. The media of claim 17, wherein the distinctive design element comprises a shape or an animal.

19. The media of claim 17, wherein the presenting occurs responsive to receiving a command queue from an administrator.

20. The media of claim 17, further comprising allowing the individual user to select a character from the graphical user interface by swiping the cursor over the character while pressing a cursor-control mechanism button.
